(19) United States
(12) Patent Application Publication
(10) Pub. No.: US 2011/0246371 A1
(43) Pub. Date: Oct. 6, 2011

(54) ENCODING OF A BANK TRANSFER

(76) Inventor: Felix Puetsch, Bergisch-Gladbach (DE)

(21) Appl. No.: 13/119,201

(22) PCT Filed: Apr. 14, 2009
(86) PCT No.: PCT/EP2009/005784

§ 371 Date: Jun. 21, 2011

(30) Foreign Application Priority Data
Oct. 14, 2008 (DE) 10 2008 051 214.1

(51) Int. Cl. G06Q 20/00

(52) U.S. Cl. 705/64

(57) ABSTRACT

Process for encoding and/or decoding of the contents of data fields of a form, the contents of several data fields being combined into a first character chain, this first character chain being encoded in the corresponding number of bits into a corresponding first bit code, and this first bit code by means of second encoding, especially using 6 bits per character, being converted into a second character chain, this second character chain conversely being decodable/decoded into the contents of the data fields.

The invention relates to a process for encoding and/or decoding of the contents of data fields of a form.

Conventionally the individual data fields of a form on the user surface of a computer are inserted individually by hand or transferred into the corresponding fields by copying and insertion. This is a conventional application and procedure for example when entering data in banking software or an Internet page of a bank for effecting a transfer in on-line banking or on-line buying.

The disadvantage here is that this procedure is very fault-susceptible and very time consuming for the user. Furthermore problems arise with blank spaces when for example a bank routing code is to be inserted into the corresponding data field by copying and inserting and this bank routing code contains blank spaces. Thus it is not possible to insert a 10 character-long character chain with a total of two empty spaces into the corresponding data field which is intended solely for 8 characters of a bank routing code.

The object of the invention is to make available a process for encoding and/or decoding the contents of data fields of a form which overcomes the indicated defects and to simplify or automate the completion of a form, especially to minimize the time expenditure for completing such a form and to help avoid errors in completing the form.

This object is achieved as claimed in the invention by a process as claimed in claim 1. Advantageous developments of the process as claimed in the invention are given in the dependent claims.

It is especially advantageous in the process as claimed in the invention for encoding and/or decoding of the contents of data fields of a form that the contents of several data fields are combined into a first character chain, this first character chain is encoded in the corresponding number of bits into a corresponding first bit code, and this first bit code by means of second encoding, especially using 6 bits per character, is converted into a second character chain, this second character chain conversely being decodable/decoded into the contents of the data fields, especially after the decoding is broken down into the individual contents of the individual data fields.

In the process as claimed in the invention thus all necessary data, i.e. the contents of the different data fields, are combined into a first character sequence. This first character sequence has a corresponding space requirement in bits and is accordingly encoded in the required number of bits.

The first bit encoding generated in this way can then be accommodated for example using 6 bits per character, i.e. using a 64 character set, in a number of characters which has been reduced accordingly by the factor 6. In this way for example all data which are necessary for a transfer, such as the recipient, bank routing code, account number and purpose can be combined and represented in a single cell. But alternatively also any other encoding than the encoding named simply by way of example can be carried out by means of the 6 bit character set. Thus, alternatively other encodings can be chosen, for example when a still shorter second character chain is to be generated.

This second character chain can conversely be easily decoded into the individual contents of the data fields by corresponding conversion of the second character chain back into the first bit code and then conversion of this first bit code back into the first character chain which then contains all the required data in clear text.

Preferably the checksum is formed from the first and/or from the second character chain. Especially preferably at least one other character as the checksum is added to the second character chain. This other character as the checksum can be added anywhere, preferably the character is attached to the end of the second character chain.

The data fields of the form, i.e. the contents of these data fields, can be the data set of a database, data file or the like.

Preferably a second character chain which has been generated according to the process as claimed in the invention is obtained and decoded; by means of the first character chain obtained therefrom the data being automatically inserted into the corresponding form and/or in the data fields of a data base.

Preferably the data are transfer data which preferably contain an identification of the payment recipient and/or an account number and bank routing code of the payment recipient and/or an IBAN of the payment recipient, especially an amount to be transferred, especially a currency and an amount, especially information on the purpose.

This yields an especially preferred application of the process as claimed in the invention for use in on-line transfers in which the data necessary for the transfer form can be made available in the form of the second character chain in order to thus prevent possible errors in the transmission of the individual data and to make available all data necessary for the form for effecting the on-line transfer.

The identification of the payment recipient can be a designation or a name, a company name or the like. The IBAN is the international bank account number by means of which unambiguous identification of a bank link in an international payment transaction is possible. The international bank account number (IBAN) is an international, standardized notation for bank account numbers. Alternatively or cumulatively the account number and the bank routing code of the payment recipient can be contained, as are conventionally given in domestic transfers.

If the data set also furthermore contains the amount to be transferred, especially with indication of the currency and/or information on the purpose, it is possible to combine all the data to be conventionally input in a transfer by means of the process as claimed in the invention and to make them available in a single second character chain, by which corresponding input errors can be avoided and the time expenditure is reduced.

For reasons of security however indication of the currency and amount or only the amount information can be intentionally omitted for domestic transfers so that it must be expressly indicated in addition. In this way misuse can be prevented.

Preferably the first and/or the second character chain is encoded/decoded using a standardized character set, especially using the character set according to ISO 664, i.e. the ASCII character set, or using the character set according to ISO 10646, i.e. the so-called unicode character set, also called the universal character set UCS.

Preferably the data are transfer data, a second character chain being obtained and decoded; by means of the first character chain obtained therefrom the data being inserted into a corresponding form.

This makes it possible to automatically insert all data necessary for a transfer into a corresponding transfer form in online banking, i.e. that a corresponding form on the user surface which is available to the user can be automatically completed without this requiring special time expenditure and without an erroneous input being inadvertently possible.

Preferably the second character chain is made available as a link, especially as a link on an Internet page, and/or as a character chain in an E-mail. Thus there are different possibilities for carrying out the process as claimed in the invention. Thus, for example the correspondingly encoded second character chain can be made available as a web link or the like of as a link with a certain command or as a code, for example in an E-mail.

Preferably the second character chain is prepared in the handling of a transaction over a computer network using the transaction data and is made available for retrieval and/or is set up on a certain Internet page and/or transmitted to a recipient. In particular the transfer data for payment of a purchase price of the transaction can be encoded and/or made available and/or transmitted in this way.

Especially preferably this process is used accordingly in on-line handling of purchase/sales transactions by such a second character chain being automatically generated in the confirmation of the sale of a certain article and encoding the payment data for transfer of the purchase price to the vendor by means of the process as claimed in the invention.

Alternatively or cumulatively the process as claimed in the invention can however generally be used in on-line transactions in order to encode order data such as supplier and/or product recipient and/or type of product, number of products, order number, purchase price, and the like and to make them available for further processing in the corresponding form fields and/or data base fields.

To increase the security of the process as claimed in the invention, in one preferred embodiment the second character chain is encrypted and prepared and/or transmitted in encrypted form.

One especially preferred application of the process as claimed in the invention is to encode all data of an online transfer for payment of an amount to a recipient in a special link.

A typical transfer contains the following data:

recipient

bank routing code (BLZ)

account number

purpose

Example:

Hans Mustermann

20 041 111

39 457 19

order E02389517

To date these data must be input by hand into the corresponding fields of the banking software or on the Internet page of the bank into the corresponding data fields. If this is to be done by copying and insertion, problems arise with blank spaces such as for example in the bank routing code when the corresponding input field is intended for input of the bank routing code only for 8 characters, the bank routing code however is formatted for 10 characters since two empty spaces are contained.

In the process as claimed in the invention, all data of the transfer are combined into a first character sequence.

recipient (20 characters from the alphabet of 40 characters (a-z, 0-9, ≅ η̅β)>→107 bit space requirement

BLZ (10000000 to 89999999)>→roughly 27 bit space requirement

account number (8-place)>→27 bit space requirement

purpose (20 characters from the alphabet of 40 characters (a-z, 0-9, ≅ η̅β)>→roughly 107 bit space requirement

This character sequence is used to complete the transfer beforehand in the banking software.

>→The entire transfer is encoded into roughly 268 bits and can be accommodated using [a-z, A-Z, 0-9,−_], therefore 6 bits per character, in 45 characters+1 character checksum, i.e. bit encoding of the first character sequence can be recoded in this way into the second character sequence.

The entire display of this second character sequence thus fits into one line (80 characters).

This process as claimed in the invention for encoding of the data required for a transfer can be used for different versions, of which for example 3 versions are displayed below:

Version 1:

Client software is installed on the customer computer (either separately or in the future as a component of the OS or home banking software)

Transfer data are made available for example by a vendor by mail as a special link in the form of an encoded second character chain: money://AZetgWjeU . . .

When clicked, the link is evaluated (here via the special command “money”) and the client software completes the form in the home banking program or on the transfer web page by the second character chain obtained “AZetgWjeU . . . ” being decoded and evaluated.

Version 2:

Transfer is made available for example by a vendor by E-mail as a web link: http://money.telekom.de/?aZetgWjeU . . .

When clicked, a Web page is reached which can transfer the data to the customer bank.

Version 3:

Transfer is made available for example by a vendor by mail as a code: aZetgWjeU . . .

This code can be processed by a home banking program or can be input directly for decoding and evaluation into the Web form of the home bank.

The versions can also be combined and can have different advantages and disadvantages with respect to the required support of third parties (for example banks, software manufacturers).

1. (canceled)

2. The process as claimed in claim 13, wherein a checksum is formed from the first or the second character chain.

3. The process as claimed in claim 13, wherein at least one further character as a checksum is added to the second character chain.

4. The process as claimed in claim 13, wherein the data fields of the form are a data set of a database.

5. (canceled)

6. The process as claimed in claim 13, wherein the data are transfer data which contain the identification of the payment recipient or an account number and the bank routing code of the payment recipient or an EBAN of the payment recipient or an amount to be transferred.

7. The process as claimed in claim 13, wherein the first or the second character chain is encoded/decoded using a standardized character set according to ISO 646 or ISO 10646.

8. The process as claimed in claim 13, wherein the data are transfer data and the second character chain is obtained and decoded by the first character chain and the data obtained therefrom is inserted into the corresponding form.

9. The process as claimed in claim 13, wherein the second character chain is made available as a link on an Internet page, or as a character chain in an E-mail.

10. (canceled)

11. The process as claimed in claim 13, wherein the second character chain is encrypted.

12. A computer program product with program instructions or means for executing the steps of the process as claimed in claim 13 in the execution of the computer program on a data processing system.

13. A process for encoding and decoding of contents of data fields of a form, the process comprising the steps of sequentially:
combining the contents of several data fields into a first character chain,
encoding this first character chain into a corresponding first bit code having a plurality of bits,
reencoding this first encoded bit code and thereby converting the reencoded first bit code into a second character chain having a number of bits less than that of the first character chain,
transmitting this second character chain to handle a transaction over a computer network using transaction data;
conversely decoding this second character chain back into the first bit code;
converting the first bit code back into the first character chain; and
inserting the data of the first character chain back into corresponding fields of a form. contents of the data fields.
